(19) United States
(12) Patent Application Publication
(10) Pub. No.: US 2008/0091574 A1
(43) Pub. Date: Apr. 17, 2008

(54) Assistance in picking system

(75) Inventors: Shinji Hamaji, Nagoya-shi (JP); Seiji Ushida, Nagoya-shi (JP)

Correspondence Address: BIRCH STEWART KOLASCH & BIRCH, PO BOX 747, FALLS CHURCH, VA, 22040-0747, US

(73) Assignee: TOA Holdings, Inc.

(21) Appl. No.: 11/892,491

(22) Filed: Aug. 23, 2007

(30) Foreign Application Priority Data
Oct. 11, 2006 (JP) JP2006-277069

(51) Int. Cl. G06Q 10/00

(52) U.S. Cl. 705/28

(57) ABSTRACT

The present assistance in picking system assists in a putting-in operation to put an article, about which instructions have been issued, in storage sections on storage racks and a picking operation to pick articles, about which instructions have been issued, from the storage section. The system assigns positions of storage sections on the storage racks, stores assigned positional information of the storage sections, and stores article information of the articles to be stored in the storage sections in a storage device. The system outputs to a putting-in display response device information of articles that have been put in, information which is read from the storage device, and outputs to a picking display response device information of articles that have been picked, including articles that have yet to be picked, as well as the numbers thereof, thereby performing picking control. A display which displays for an operator work of the putting of articles into the storage sections is provided to the putting-in display response device and a display which displays work of picking articles from the storage sections for the operator and a completion switch which inputs completions in picking are provided on the picking display response device. A picking control computer controls assistance in both operations to put articles in and an operation to pick articles from the storage sections of the storage racks, on the basis of a single piece of positional information and article information for each of the storage sections that is stored in the storage device.

### BACKGROUND OF THE INVENTION

1. Field of the Invention

The present invention relates to an assistance in picking system for use on storage racks. In such system, a display response device is equipped on each storage section of the storage racks where the articles are stored, and an operator picks articles from an article storage tray which is indicated by the location display lamp of a display response device.

2. Description of the Related Art

Conventionally, a storage rack incorporating an assistance in picking system has been known as a system equipped with display response devices and switches equipped on each of storage box where products and parts are stored so that an operator can pick products and parts correctly from a storage box as instructed from the lighting of the display response devices.

As described in Japanese Patent Application Laid Open Publication No. Hei 7-291412, the conventional storage rack incorporating an assistance in picking system comprises a fixed rack provided with many storage sections for storing parts, each of which is fixedly constituted of supporting posts and shelves, etc. which are specially machined for the purpose. Further, the display lamp that indicates location of a fixed storage box to be picked, and switches to input the completion of picking after a part has been picked, are fixedly attached to a picking unit provided on each of the storage sections for storing parts.

A lighting signal which is sent to such a display lamp, and a switch signal which is generated by such a switch, are controlled by a picking unit provided on each of the fixed storage section. A picking unit is constituted of a small-sized control computer, in which a display lamp and a switch provided on each of the storage sections for storing parts are connected to input/output ports of the control computer.

It should be noted that ordinary storage racks including one incorporating an assistance in picking system disclosed in the above publication has a structure that putting-in and picking operations of articles are provided from the same side of the fixed rack, and the display lamps are shared for instructing both putting-in and picking operations. This factor has entailed a risk that some operators might make a mistake in distinguishing between the two operations.

Another storage rack has been conventionally known has a structure that separated display lamps are located at the front and rear sides of the fixed rack and gives instructions for the putting-in and for the picking of parts respectively. In an assistance in picking-system for use in this type of conventional storage rack, an putting-in display lamp and a picking display lamp, as well as switches, are independently connected and controlled by each control unit. Accordingly, in order to change settings of a storage section on a rack, it is necessary to make significant changes in layout of electrical wiring which are connected to the display lamps for putting-in and picking as well as the switches. The tasks involving in such changes in setting can be carried out only by an operator with technical knowledge of electrics and the task has tended to become complicated and irksome.

### SUMMARY OF THE INVENTION

It is an object of the present invention to provide an assistance in picking system for storage racks that is capable of carrying out smoothly and appropriately operations undertaken both to put in and pick articles.

It is another object of the present invention to provide an assistance in picking system for storage racks that is capable of easily setting storage sections so as to conform to the articles to be stored, and that is also capable of changing the settings.

To this end, the assistance in picking system of the present invention assists in a putting-in operation which means to put articles into a storage section on storage racks as instructions have been issued, and a picking operation which means to pick articles from the storage section as instructions have been issued, comprising: a storage section information-storage means that assigns positions of the storage sections of the storage racks, that stores assigned positional information about the storage sections, and that stores article information about the articles to be stored in the storage sections; a picking control means that outputs to a putting-in display response device information about articles that have been put in, including articles that are yet to be put in, which information has been read from the storage section information storage means, and outputs to a picking display response device information of articles that have been picked, including articles that are yet to be picked, as well as the numbers of the articles picked; a putting-in operation display means that is provided on the putting-in display response device and that displays a putting-in operation to the storage section to an operator; and a picking operation display means that is provided on the picking display response device and that displays a picking operation from the storage section for the operator, wherein the picking control means is arranged so as to control assistance in both an operation to put in the articles and an operation to pick articles from the storage sections of the storage racks, on the basis of single items of positional information and article information for each of the storage sections that is stored in the storage section information-storage means.

It should be noted that in the assistance in picking system described above, a general purpose computer can be used to allocate the storage sections for articles, in which case the storage sections of the storage racks are displayed in cell format on screen. Thereby, the allocation of the storage sections can be set by inputting an identification code of each storage section to the corresponding cell. In the storage section information-storage means described above, it is possible to store as table data which corresponded to the name or the indication code of an article to be stored in the storage section and the identification code of each of the storage sections.

According to the assistance in picking system with the structure described above, the picking control means controls and assists both operations of putting-in and picking an article to/from each of the storage sections of the storage racks, on the basis of single items of positional information and article information that is common to the storage sections that is stored in the storage section information-storage means. Thus, if the article storage section is changed, this change is reflected in both the putting-in information and picking information of the storage section, thus facilitating changing of settings of the article storage sections with an unerring degree of precision. Also, at a time of operations relating both putting-in and picking, it is possible to give instructions simultaneously to both operators in charge of putting-in and in charge of picking, and thereby it is capable of performing efficient instruction display on the storage sections.

Furthermore, for example, in the case of changing settings of which storage sections of a storage rack are to be allocated to store articles, it is possible to read information on the allocation on the storage sections of storage racks stored in the storage section information-storage means and to input the identification codes of these storage sections in the cell that indicate the arrangement of the storage sections on the storage racks. Thus, it is possible to make changes efficiently and easily to the settings of the storage sections in which the respective articles are stored, by virtue of visually understanding positions of the storage sections on the rack. Also, in cases when identification codes of the storage sections have already been input in the cell that reflects the arrangement of the storage sections, a general purpose computer can be operated to shift the identification codes to different cells, thereby efficiently, easily, and precisely changing the settings of the storage sections in which the respective articles are stored.

Moreover, the names and codes of articles to be stored in the storage sections and the identification codes of the storage sections are stored as single data table thus when changes are made to the storage sections in which the articles are stored, as identification codes of the storage sections, the identification codes of the putting-in display response devices and those of the picking display response devices which are attached to these storage sections can be set in common with each other and thus setting can be performed with an unerring degree of precision.

### BRIEF DESCRIPTION OF THE DRAWINGS

FIG. 1 is an overall constitutional view of an assistance in picking system for storage racks showing one embodiment of the present invention;

FIG. 2 is a plan view of the storage racks;

FIG. 3 is a constitutional view of a putting-in display response device;

FIG. 4 is a constitutional view of a picking display response device;

FIG. 5 is a constitutional view of a picking control computer;

FIG. 6 is a constitutional view of a rack-setting computer;

FIG. 7 is an explanatory view of an input screen for setting an allocation of storage sections of racks by means of a rack-setting computer;

FIG. 8 is an explanatory table of a master data table indicating a relationship among names and symbols of articles to be stored and identification codes for storage sections;

FIG. 9 is a flowchart showing operations at a time of putting articles into the storage sections on the storage racks;

FIG. 10 is a flowchart showing operations at a time of picking articles from the storage sections on the storage racks;

FIG. 11 is an explanatory table showing a relationship among work instruction numbers, article symbols, and the number of articles to be picked that are contained in data of picking work instruction stored in the picking control computer; and

FIG. 12 is an explanatory view of a table showing details of set symbols “S01” and “S02” in the table of FIG. 11.

### DESCRIPTION OF THE PREFERRED EMBODIMENTS

A description follows of the present invention according to the embodiments shown in the drawings. It should be noted that the present invention is not limited to these embodiments. All changes to what is required in claims, or to equivalents about such requirements, are covered by the claims.

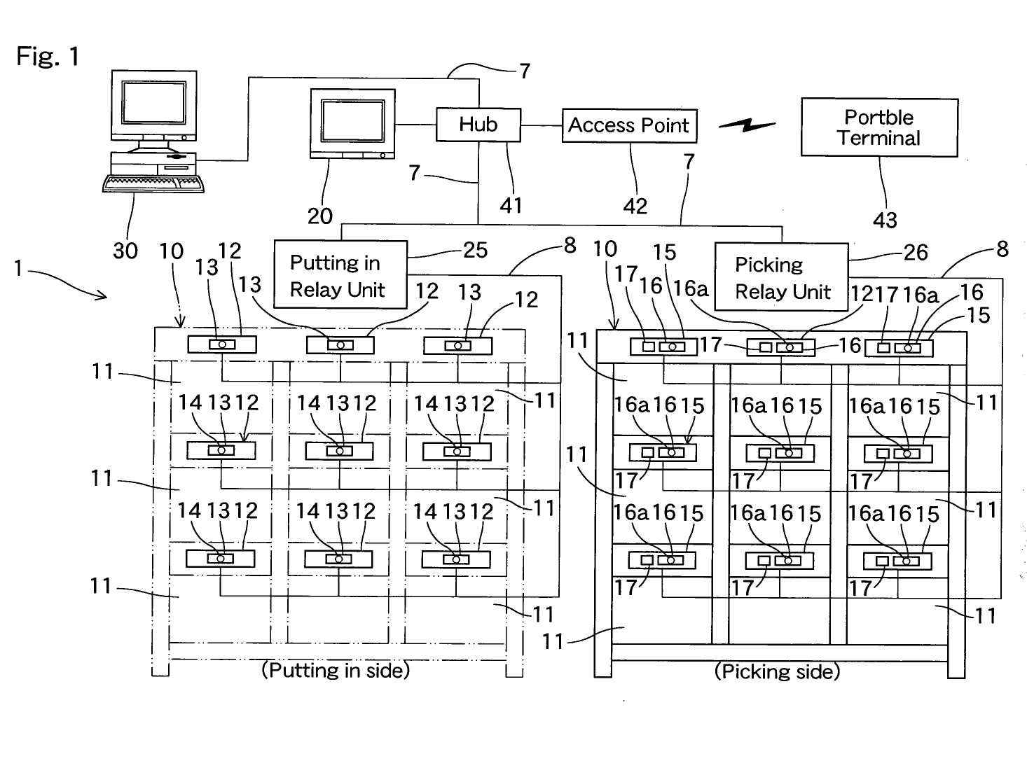

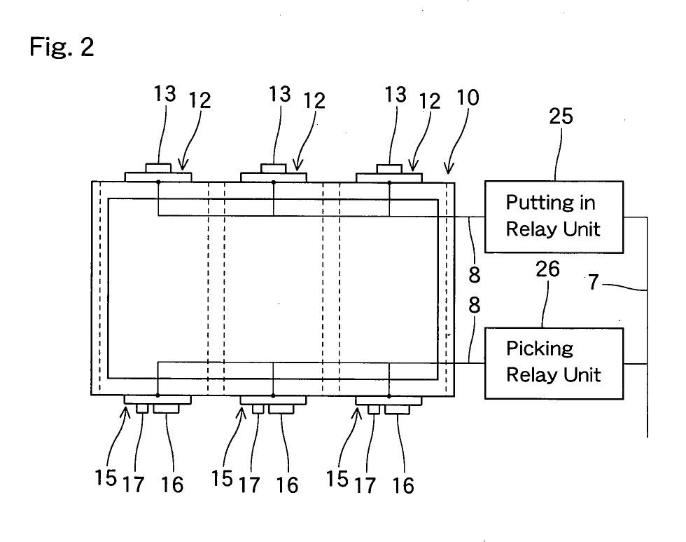

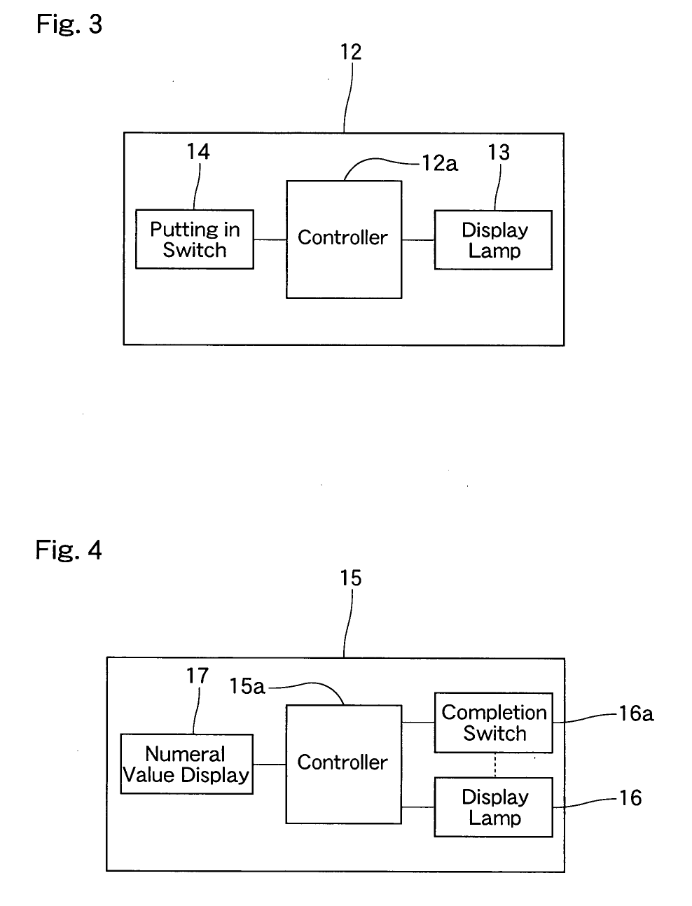

A pair of storage racks 10 to which the assistance in picking system of the present invention applies have a basic constitution such that one of the storage racks 10 is provided for the putting-in of articles so that a putting-in display response device 12 may be attached to each of its storage sections 11, and the other storage rack 10 is provided for picking articles so that a picking display response device 15 may be attached to each of its storage sections 11. Thus, control can be conducted on assistance of both an operation to put in articles and an operation to pick articles from the storage sections 11 that are arranged both vertically in parallel to each other and horizontally on the storage racks 10, on the basis of single items of positional information and article information. FIG. 1 shows an overall constitutional view of the assistance in picking system of the storage racks 10 and FIG. 2 shows a plan view of the storage racks 10.

First, the storage racks 10 will be explained below. A storage rack 10 is formed in the shape of a rack with the use of supporting posts, shelves, etc., in a constitution such that a plurality of storage sections 11 can be arranged in the interior of the storage rack 10 for storing articles such as products and parts. In an example in the figure, although nine (three rows by three columns) storage sections 11 are formed on the rack, the number of the storage sections 11 is not limited to this example. Also, as described above, a storage rack 10 is open at both front and rear sides thereof in a constitution such that a putting-in display response device 12 is attached to each of the storage sections 11 of one side (for example, the rear side), thus forming an article putting-in section, and a picking display response device 15 is attached to each of the storage sections 11 of the other side (for example, the front side) thereby forming an article-picking section.

Such a storage rack 10 is, for example, in a manufacturing line in a factory for manufacturing a variety of types of machines, used as a rack on which are stored various parts that are used in manufacturing, thereby assisting an operator in picking the parts to be used at various points along the manufacturing line. Therefore, although only one storage rack 10 is shown in FIG. 1, in a case where a product to be manufactured along the manufacturing line needs several hundreds of parts, for example, several tens of storage racks 10 can be arranged in parallel to each other so that many storage racks 10 may be connected to a picking control computer 20 via a LAN cable 7, a putting-in relay unit 25, and a picking relay unit 26. It should be noted that articles that can be stored in the storage sections 11 may include, besides various parts that are used along the manufacturing line, baggage that can be placed in a distribution process.

The putting-in display response device 12 is constituted by attaching a display lamp 13 for a putting-in operation to its rear side and that will light up to indicate the storage section 11 on the rack in which an article is to be put. Also, the display lamp 13 incorporates a location display lamp as well as a putting-in switch 14 which is turned on when the operator puts in an article, the display lamp 13 thus possessing both display and switch functions. The putting-in display response device 12 is mainly constituted of a controller comprising items such as a CPU, a ROM, a RAM, and an input/output circuit and has on its front surface the display lamp 13 incorporating the putting-in switch 14 described above.

The putting-in operational display lamp 13 and the putting-in switch 14 are connected to the input/output circuit of the controller. The putting-in display response device 12 operates on the basis of program data written into the ROM in advance, and receives putting-in information of an article transmitted from the picking control computer 20 and sent via the putting-in relay unit 25, and, on the basis of the putting-in information, lights up the putting-in operational display lamp 13. Furthermore, the putting-in display response device 12 stores a putting-in confirmed state if the putting-in switch 14 in the display lamp 13 is turned on when the operator puts in an article, and, upon reception of a polling control signal sent from the putting-in relay unit 25, transmits the putting-in confirmed signal to the putting-in relay unit 25.

Therefore, a putting-in display response device 12 in each of the storage sections 11 is connected to the putting-in relay unit 25 via a communication line on the basis of, for example, a two-wire communication system of, the RS-485 standards. Since a plurality of putting-in display response devices 12 are connected to the one putting-in relay unit 25, in order to differentiate between each putting-in display response device 12, various addresses are set to the different putting-in display response devices 12. Also, a putting-in display response device 12 is equipped with a reception section and a transmission section for the purpose of data communication of, for example, RS-485 standards. Furthermore, the putting-in relay unit 25 is connected to the picking control computer 20 via the LAN cable and a hub 41.

On the other hand, a picking display response device 15 is attached to each of the storage sections 11 on the picking side of the storage rack 10 in a constitution such that each of the picking display response devices 15 is equipped on its front surface with a display lamp 16, that indicates an instruction for picking, and a numerical value display 17 that indicates the number of articles to be picked. A display lamp 16 incorporates a location display lamp as well as a completion switch 16a, which is turned on when the operator has picked an article, and the display lamp 16 thus possesses both display and switch functions.

A picking display response device 15 is mainly constituted of a controller comprising items such as a CPU, a ROM, a RAM, and an input/output circuit and has on its front surface a display lamp 16 for indication of picking operations and the numerical value display 17. The display lamp 16 is equipped with a location display lamp, which lights up on receipt of a picking command signal, and the display lamp 16 also incorporates a completion switch 16a, which is turned on upon the completion of the picking of an article by an operator. In this example, the location display lamp and the completion switch 16a are built into the display lamp 16 so that the display lamp 16 possesses both display and switch functions; however, the location display lamp and the completion switch may be provided independently of each other.

As shown in FIG. 4, the display lamp 16 and the completion switch 16a are connected to the input/output circuit of the controller 15a in the picking display response device 15. A numerical value display 17, which indicates the number of articles to be picked, is constituted of, for example, a seven-segment LCD (liquid crystal display) and is connected to the input/output circuit of the controller.

The picking display response device 15 operates on the basis of program data written into the ROM in advance, receives picking information that has been transmitted from the picking control computer 20 and sent via the picking relay unit 26 and, on the basis of the picking information, lights up the display lamp 16 and also indicates the number of articles to be picked on the numerical value display 17. Furthermore, after an operator performs picking operations on the basis of the picking information and, when the completion switch 16a has been turned on, a picking display response device 15 stores a completion of picking state. Moreover, upon receipt of the polling control signal sent from the picking relay unit 26, the device 15 transmits the picking completion signal to the picking relay unit 26.

Therefore, as shown in FIG. 1, a picking display response device 15 in each of the storage sections 11 is connected to the picking relay unit 26 via the communication line 8 on the basis of a two-wire communication system of, for example, RS-485 standards. Since a plurality of the picking display response devices 15 are connected to a single picking relay unit 26, in order to make a differentiation between each picking display response device 15, various addresses are set to the different picking display response devices 15. Also, a picking display response device 15 is equipped with a reception section and a transmission section for the purpose of data communication of, for example, RS-485 standards. Furthermore, a picking relay unit 26 is connected to the picking control computer 20 via a LAN cable, a hub 41, etc.

A picking relay unit 26 is constituted of a single-board computer comprising a CPU, a ROM, a RAM, and an input/output circuit, has an LAN interface, and is connected to the picking control computer 20 via a wireless LAN or a LAN cable so as to carry out mutual communications by use of a communication protocol such as TCP/IP. Usually, a plurality of picking relay units 26 are installed, and each has an assigned IP address in order to differentiate between each of the picking display response devices 15.

Further, a picking relay unit 26 converts picking information sent from the picking control computer 20 into a decryptable format and then transmits it to a plurality of picking display response devices 15. Further, after the transmission of the picking information to the picking display response devices 15, the picking control computer 20 sends a polling control signal to the picking display response devices 15, and receives a response signal such as a completion switch signal transmitted in response to the polling from the picking display response devices 15. Then, the picking display response device 15 converts a response signal such as the completion switch signal into a decryptable format and transmits it to the picking control computer 20.

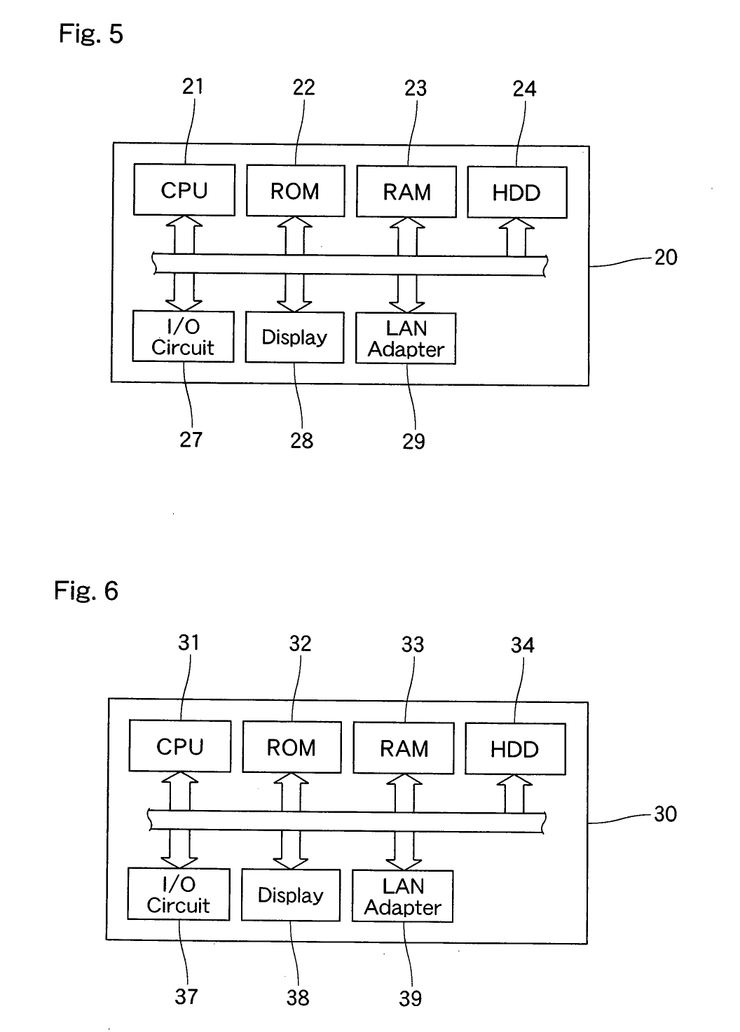

The picking control computer 20 is constituted of, for example, a general purpose personal computer as shown in FIG. 5, in a constitution such that to an LAN adapter 29 that is mounted on it, one or a plurality of putting-in display response devices 12 and one or a plurality of picking display response devices 15 are connected via the LAN cable 7. In the picking control computer 20, software prepared in advance for assisting in operations to put in and pick articles is stored in a ROM 22 or a storage device 24; so that, as described later, in a case of putting in articles, the picking control computer 20 assists in the putting-in operation on the basis of put-in article data sent from a portable terminal 43, and in the case of picking articles, the picking control computer 20 assists in a picking operation on the basis of work instruction number data sent from the portable terminal 43. For this purpose, the picking control computer stores in advance, information such as identification codes of the storage sections 11 of the storage racks 10, the numbers of articles to be stored and the numbers of articles already stored, in the format of a data table.

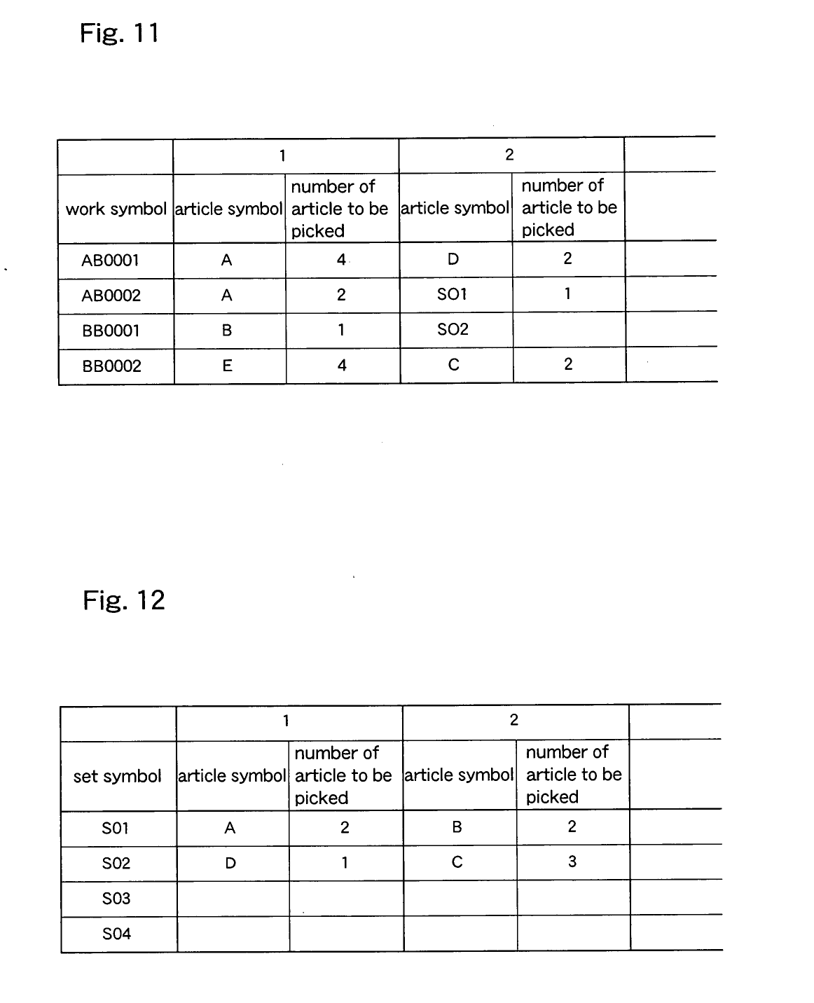

Moreover, in the storage device 24 of the picking control computer 20, information such as the work instruction numbers for picking shown in FIGS. 11 and 12, the article symbols of the corresponding articles, the number of articles to be picked is stored in advance as a database. In the table of work instruction numbers and articles shown in FIG. 11 information is displayed to the effect that for the picking work instruction number “AB0001”, in a first picking, only “4” units of articles with a symbol “A” are picked and that in a second picking, only “2” units of articles with a symbol “D” are picked, and thus information is then stored in the database. Also, in the second row in the table of FIG. 11 information is displayed to the effect that for the picking work instruction number “AB0002”, in a first picking, only “2” units of articles with a symbol “A” are picked and that in a second picking, only “1” unit of article with a set symbol “S01” is picked, and this information is then stored.

It should be noted that, in the case where a plurality of types of articles is picked as a set, the set symbol “S01” indicates a plurality of types of articles; set symbols “S01” and “S02” are article symbols which are used when articles are picked as a set as shown in FIG. 12, and the number of articles to be picked is stored as table data in the database in the storage device 24 of the picking control computer 20. For example, the set symbol “S01” indicates that only “2” units of articles with a symbol “A” will be picked and that only “2” units of articles with a symbol “B” will be picked. In cases where a task of picking a plurality of types of articles as a set occurs twice or more, data of these set symbols can be created and input simply.

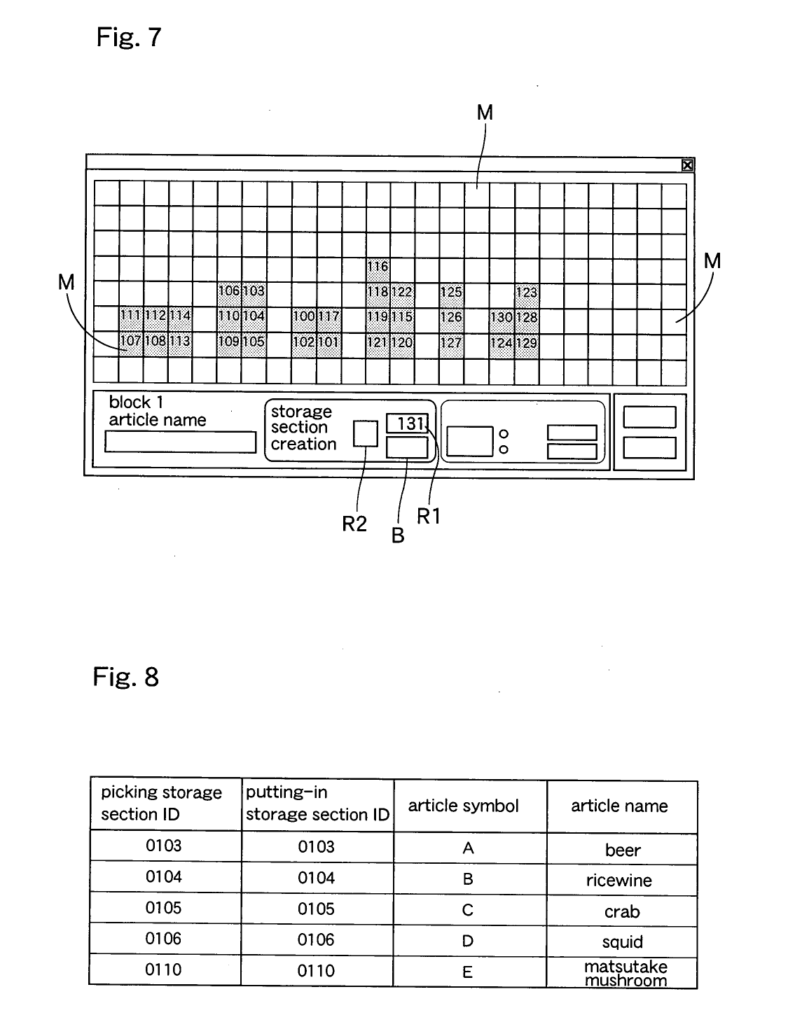

Furthermore, as shown in FIG. 1, a rack-setting computer 30 is connected to the picking control computer 20 via the LAN cable 7 and the hub 41. The rack-setting computer 30 is constituted of, for example, a general purpose personal computer and comprises a CPU 31, a ROM 32, a RAM 33, a storage device 34, an input/output circuit 37, a display 38, and an LAN adapter 39, as shown in FIG. 6. In the rack-setting computer 30, rack setting software that is prepared in advance is stored in the ROM 32 or in the storage device 34, and this software will display a storage section allocation input screen on which storage sections 11 are allocated for articles on the storage racks 10, as shown in FIG. 7. On the storage section allocation input screen, identification codes of the storage sections are input so as to allocate the corresponding storage sections on the racks. The storage section information-storage means described above is constituted of a ROM 32 and a storage device 34 in the rack-setting computer 30.

If this rack-setting application software is activated in the rack-setting computer 30, a storage section allocation input screen, as is shown in FIG. 7, will appear on the screen of the display 38. As shown in FIG. 7, the storage section allocation input screen provides mesh-shaped display of the storage sections 11 of the storage racks 10 as the cell M so that identification codes (for example, numbers 131, 118, 120, etc.) of the storage sections 11 may be input into the cell M. Specifically, by means of inputting an identification code into an identification code input field R1, and by means of clicking on a creation button B positioned below it, an identification code (for example, 131) is displayed in a field R2 in FIG. 7. Then, an operator can drag the field R2 and drop it into a desired cell M, and thereby set the storage section 11 for a desired article to the cell M at an arbitrary position. Also, even after an identification code has been input into a cell M, an operator can drag and drop the identification code, and thereby move it to an arbitrary position.

Further, information of an article symbol and the name of an article, which corresponds to an identification code of the storage section 11, and which is to be stored in it, are stored in the rack-setting computer 30 as an item such as the master data table of FIG. 8; therefore, if the name of an article corresponding to an identification code of the relevant storage section 11, is stored in advance, when the identification code is displayed in the field R2 on the above-described storage section allocation input screen, the name of the article is displayed in an article name field R3 located to the left thereof. It thus becomes possible for an operator to confirm in the article name field R3 the name of an article that is to be stored in the storage section 11 which the operator has set.

In such a manner, an operator can allocate the storage sections corresponding to the articles in such a manner as to be able to easily put in or pick efficiently an article in which the operator has an interest by virtue of visually confirming positions of the storage sections 11 on the storage racks 10, that is, by means of visualizing the positions of the storage sections 11 on the actual storage racks 10 on the storage section allocation input screen. Also, on the storage section allocation input screen, it is possible to perform very efficiently and quickly tasks such as increasing or decreasing the number of storage sections 11 in which articles are stored or such as changing layouts of storage sections 11. It should be noted that a format for displaying the cell M on the storage section allocation input screen can be switched between a condition where the storage racks 10 are viewed from the putting-in side and a condition where they are viewed from the picking side.

Moreover, according to the software for setting in the rack-setting computer 30, as shown in FIG. 8, the names of articles, or the codes indicating them, are input by means of a table creation software input form, and are stored in the storage sections corresponding to identification codes of the storage sections as master table data. In this case, as identification codes (for example, 0103, 0104, . . . ) of the storage sections 11 or the storage racks 10, an identification code of the putting-in display response device 12 and an identification code of the picking display response device 15 are input into their respective fields as an identification code of a single common storage section 11. Storage section allocation setting master data containing the identification code of such a storage section is transferred from the rack-setting computer 30 to the picking control computer 20 and stored in the storage device 24 of the picking control computer 20, and is then used in operations performed to put in and pick articles.

It should be noted that although the rack-setting computer 30 described above is connected to the picking control computer 20 via the LAN cable 7, it can also be connected with the use of a wireless LAN, or it can be installed independently so that data such as storage section allocation setting master data created by the rack-setting computer 30 can be stored in a storage medium such as an FD, a CDR, or a semiconductor storage device, and then transferred to the picking control computer 20.

On the other hand, as shown in FIG. 1, a wired LAN system which interconnects the picking control computer 20, the putting-in display response device 12, and the picking display response device 15, is also connected with a wireless LAN system which includes an access point 42 and a portable terminal (personal digital assistant) 43. As the wireless LAN system, for example, a wireless LAN of the IEEE802.11a standard with a service frequency in the 5 GHz-band, an OFDM (orthogonal frequency division multiplexing) modulation/demodulation system and a CSMA/CA (carrier sense multiple access with collision avoidance) access control system are also be used. In a large-sized warehouse in which many storage racks 10 are located, a plurality of access points 42 is dispersed around the storage racks 10 and assigned identification numbers that are managed by the picking control computer 20 so that the access points 42 can be accessed by a plurality of portable terminals 43.

A portable terminal 43 is mainly constituted of a microcomputer and comprises a wireless communication section which transmits and receives data wirelessly as well as a small-sized keyboard and display, and the portable terminal 43 is also equipped with a barcode reader for inputting barcodes. An operator who puts in and picks articles carries the portable terminal 43, and inputs information on the articles to be put in and to be picked into the portable terminal 43 via the barcode reader.

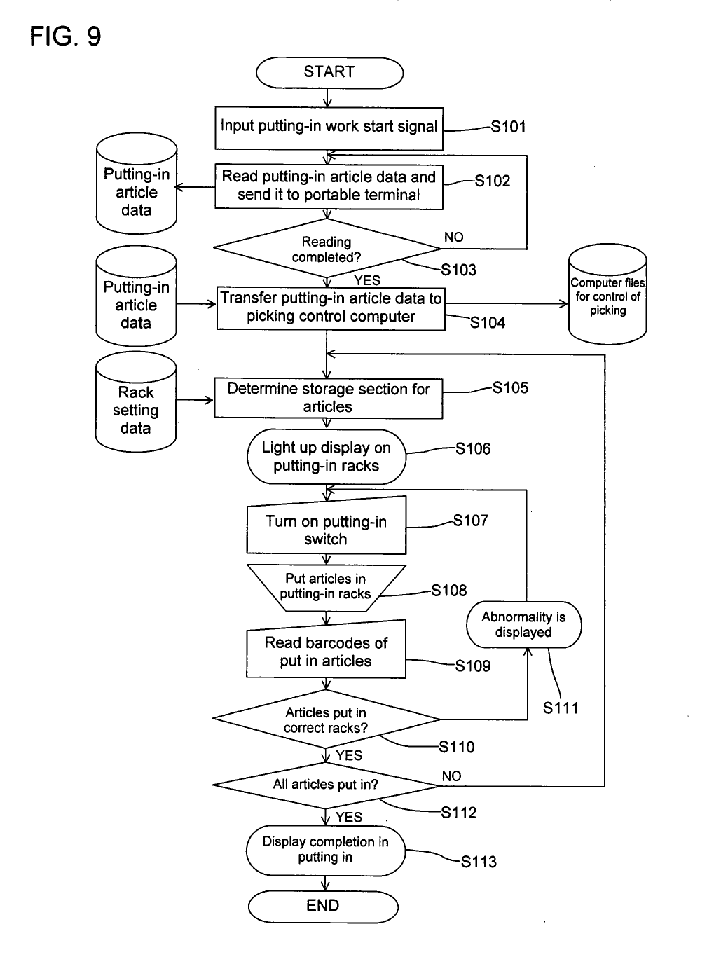

Next, the operations will be described of an assistance in picking system with the constitution described above. FIG. 9 shows a flowchart of operations for putting articles into the storage sections 11 on the storage racks 10. The following is based on the flowchart of FIG. 9 and is a description of operations for putting in articles and of assistance activities.

In cases of putting in articles, an operator first operates the portable terminal 43 so as to input operator's putting-in work start signal at step S101. Next, at step S102, the operator operates the barcode reader of the portable terminal 43 so as to reads the barcode of the article data marked on the tag etc. that is attached to the bag of the articles, or to the articles themselves through the barcode reader. The article data includes items such as article number, an article name, and information about manufacturing. Those data of articles that is yet to be put in, is stored temporarily in a memory of the portable terminal 43.

When reading of all article data for this work of putting in has been completed, the operator uses switches to input the completion signal to the portable terminal 43. In this case, the process progresses from step S103 to step S104 and data of the articles yet to be put in, such as the article number, the article name, and the information about manufacturing of the articles, are transferred from the portable terminal 43 to the picking control computer 20 via the access point 42.

Next, in order to embark on the work of putting-in, once again operates the barcode reader of the portable terminal 43, and thereby reads the barcode of the article data marked on the tag etc. that is attached to the bag of the articles, or to the articles themselves through the barcode reader. After taking in the data of the articles to be put on the storage racks 10, the picking control computer 20 determines the storage section 11 in which the articles are to be put, at step S105.

The storage section 11 in which the articles are to be put is determined by reference to data-created by the rack-setting computer 30, that is, information of storage section allocation which is generated by the input of the identification codes of the storage sections in the cell and master data of the article names, the article codes, and the identification codes (those for both putting-in and the picking) of the storage sections 11 in which articles are put, as shown in FIG. 8. Data of the identification code of the storage section 11 in which it has been decided that the articles to be put is sent to the putting-in display response device 12 of the corresponding storage section 11 from the picking control computer 20 via the putting-in relay unit 25, and lights up the display lamp 13 on the putting-in display response device 12 of that storage section 11.

Next, the operator turns on the putting-in switch 14 on the putting-in display response device 12 of the lighted-up display lamp 13 at step S107 and, at step S108, puts the articles into the storage section 11 of the putting-in display response device 12 whose numerical value display has lighted up. In this case, a switch signal containing the identification code of the putting-in display response device 12 is send to the picking control computer 20 to notify the switch has been turned on. Then, the operator reads again the barcode of the article put in through the portable terminal 43 at step S109 and the data of the article is send to the picking control computer 20.

The picking control computer 20 in turn uses the master data as reference to the article data which have thus been taken in, and decides at step S110 whether this article storage location agrees with the storage section 11 of the putting-in display response device 12 whose putting-in switch 14 has lighted up. If it is decided that this article storage location does not agree with the storage section 11 of the putting-in display response device 12 whose putting-in switch 14 has lighted up, the process progresses to step Sill and an abnormality indicator is displayed in the portable terminal 43, or in the picking control computer 20. The process then returns to step S107 and the operator is prompted to turn on the putting-in switch 14 and to put the articles into the appropriate storage section 11.

On the other hand, if it is decided that this article storage location agrees with the storage section 11 of the putting-in display response device 12 whose putting-in switch 14 has lighted up, the process progresses to step S112 and the picking control computer 20 decides whether all articles have been put in relation to the data that was read into the picking control computer 20 at the above-described step S104. If any of the articles has yet to be put in, the process returns to step S105 described above and the picking control computer 20 decides location of the storage section 11 in which the articles are to be next put.

Thus, in much the same way as described above, an operator reads the barcode on the articles to be put in through the portable terminal 43 and sends the data of the articles to the picking control computer 20. The picking control computer 20 in turn recognizes the appropriate storage section 11 for the articles on the basis of the article data and data of the storage section 11 described above and lights up the display lamp 13 on the putting-in display response device 12 of that storage section 11 at step S106.

Further, in much the same way as described above, an operator turns on the putting-in switch 14 on the storage section 11 whose display lamp 13 is lighted up at step S107 and puts the articles into this storage section 11 at step S108. At step S109, an operator reads again the barcode of the article that has been put in through the portable terminal 43, and thereby decides whether this article storage location agrees with the storage section 11 of the putting-in display response device 12 whose putting-in switch 14 has been turned on.

If this article storage location agrees with the storage section 11 of the putting-in display response device 12 whose putting-in switch 14 has been turned on, the process proceeds through the following step S112 and then steps S105 through S112 described above are repeated; if the articles whose data has been sent to the picking control computer 20 at step S104 have all been put in the storage sections 11, the process progresses from step S112 to step S113, an indication of the task completion is displayed on the portable terminal 43 or the picking control computer 20 and the current task of putting-in is thereby completed.

Although, in the above-mentioned in the state of the lighting up of the display lamp 13 on the putting-in storage racks, an operator turns on the putting-in switch 14, puts the articles into the storage section 11 and then reads the barcode of the article that has been put in, when the display lamp 13 was lighted up, the operator may operate to read the barcode of the article that will be put in and then put in the article, and turn on the putting-in switch 14 of the storage section 11.

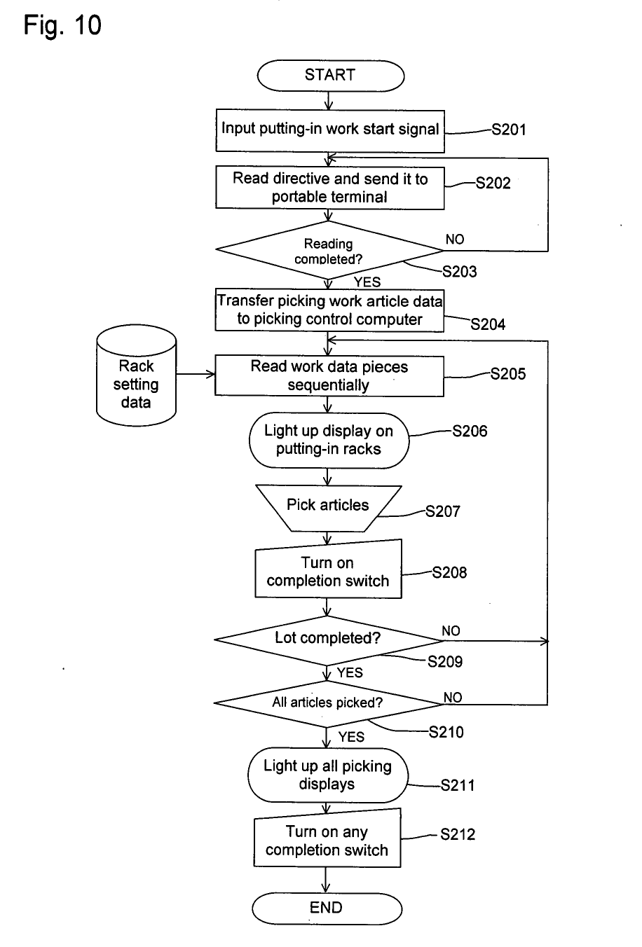

Next, operations of the picking of articles and activities of assisting in this progress will be described with reference to the flowchart of FIG. 10.

In a case in which articles are picked, an operator first operates the portable terminal 43 and inputs start signal of an article picking work at step S201. Next, at step S202, the operator operates the barcode reader of the portable terminal 43 and reads a barcode described in a picking instruction by means of the barcode reader. The picking instruction describes the barcode as well as a work instruction number of the picking work to be carried out. By reading all the barcodes described in the picking instruction, data of the work instruction number of the picking work to be carried out on this occasion is input to the portable terminal 43 and temporarily stored therein.

Having completely read the article data through the barcode reader of the portable terminal 43, an operator presses an item such as a key switch and inputs a “reading completed” signal to the portable terminal 43. In this case, the portable terminal 43 progresses from step S203 to step S204 and transfers data of the work instruction number of the picking work from the portable terminal 43 to the picking control computer 20 by way of the access point 42.

Then, the operator embarks on the actual picking work and reads, for example, a first work instruction number described in the picking instruction by using the barcode reader of the portable terminal 43. Data of this work instruction number is sent from the portable terminal 43 via the access point 42 to the picking control computer 20, which in turn reads data of an identification code of the storage section 11 of the storage racks 10 and data of the number of articles to be picked as a reference for this work instruction number at step S205 by using a database, as shown in FIG. 11, in which work instruction numbers, article numbers, the number of articles picked, etc. are stored and transmits these pieces of data to the picking display response device 15 with the corresponding address via the LAN cable 7 and the picking relay unit 26. When these pieces of data have been received, the picking display response device 15 with the corresponding address lights up its display lamp 16 and the numerical value display 17 indicates the number of articles to be picked at step S206.

After having visually confirmed the lighting up of the display lamp 16 and the number of the articles picked, the operator picks as many articles as have been directed from the storage section 11 of indicated picking display response device 15 (step S207). In the next step S208, the operator turns on the completion switch 16a on the picking display response device 15. A switch signal indicating the completion of a picking work is sent from the picking display response device 15 by way of the picking relay unit 26 to the picking control computer 20, which in turn, after receiving the switch signal, decides whether all of the picking work or the lot described in the picking instruction which taken in at the start of the work has been completed.

If it is decided that not all of the picking work for the lot has been completed, the process returns to step S205 described above, the picking control computer 20 reads the data of the identification code on the storage section 11 of the storage racks 10 and data of the number of articles with this work instruction number that are to be picked by using the database in which, for example, a second work instruction number, article numbers, the number of articles to be picked, etc. are stored. The picking control computer 20 then transmits these data pieces to the picking display response device 15 with the corresponding address. Then, in such the same way as described above, after having received a data signal for these data pieces, the picking display response device 15 with that address lights up its display lamp 16 and so indicates the number of the articles that have been picked on the numerical value display 17. Then, the operator visually confirms lighting up of that display lamp 16 and the number of articles picked, and repeats the processes extending from the picking of as many articles as have been directed from the storage section 11 of the picking display response device 15 to the turning on of the completion switch 16a.

If the process of the steps S205 through S209 described above is repeated and it is decided that all the picking work or lot, has been completed, the picking control computer 20 further decides at step S210 whether all of the articles have been picked in the course of the picking work. Once having decided that all the articles have been picked, the picking control computer 20 transmits a light-up signal to all of the picking display response devices 15, and lights up the display lamps 16 on the picking display response devices 15 of all the storage sections 11 at step S211.

With this lighting up of all the display lamps 16, an operator recognizes that the latest picking work has been completed and notifies the picking control computer 20 of this fact, and turns on a specific completion switch 16a or any other completion switch 16a at the next step S212. If the switch signal of the completion switch 16a is sent to the picking control computer 20 when the display lamps 16 are all lighted up, the picking control computer 20 recognizes the fact that picking work has been completed and completes the latest task of assistance in picking.

In such a manner, according to an assistance in picking system having the above-described constitution, the picking control computer 20 controls assistance in both operations to put in articles and pick articles from the storage sections 11 on the storage racks 10 on the basis of information of location and article which is common to the storage sections 11 stored in its storage device 24. Thus, any changes, if any, in the storage sections 11 for the articles, are reflected in both the putting-in information and picking information in the storage sections 11, thereby making it possible to change settings in the article storage sections with an unerring degree of precision. Moreover, in the course of operations of putting in and picking, it is possible to assist in both operations of putting in and of picking by transmitting and receiving both information about articles to be put in and to be picked to and from both the putting-in display response device 12 and the picking display response device 15, and by directing simultaneously an operator in charge of putting the article and an operator in charge of picking an article, thereby making it possible to perform operations of putting-in and picking articles efficiently and accurately.

Furthermore, for example, in cases where changes are made to settings of which storage racks 10 of storage sections 11 should be allocated to store articles, an operator reads the information of settings stored in the storage device 34 of the rack-setting computer 30 and then inputs the identification codes of these storage sections 11 in the cell which indicate arrangement of the storage sections 11 on the storage racks 10, and thus the change can be made efficiently and easily by virtue of visually understanding positions of the storage sections on the racks. Also, in cases where the identification codes of the storage sections 11 have already been input in the cells which indicate arrangements of the storage sections 11, the rack-setting computer 30 can be operated in such a way as to move those identification codes to different cells, thereby facilitating the efficient changing of settings of storage sections in which the respective articles are stored, with an unerring degree of precision.

Moreover, since the names and codes of articles to be stored in the storage sections and the identification codes of the storage sections 11 are stored as a single data table, when changes are made to the storage sections 11 in which the articles are stored, identification codes of the putting-in display response device 12 and those of the picking display response devices 15 that are attached to these storage sections 11 can be set in common with each other as single identification codes, and thus setting can be performed with an unerring degree of precision.

Although in the above embodiment the rack-setting computer 30 and the picking control computer 20 are used, the functions of the rack-setting computer 30 may alternatively be incorporated into the picking control computer 20, thus making it possible for the setting allocation of the storage sections on the racks and the control of article picking to be performed by means of the picking control computer 20.

Although in the above an operator has used the portable terminal 43 to input the putting-in start signal and the picking start signal so that information of articles to be put in and to be picked_may be input by means of a built-in barcode reader, these signals and picking information may alternatively be input by means of a computer connected via a wired LAN instead of a wireless LAN, or by means of a barcode reader connected to the computer.

What is claimed is:

1. An assistance in picking system comprising:
a storage section information-storage means that assigns positions of storage sections of storage racks in which articles are stored, stores assigned positional information of the storage sections, and stores article information of the articles to be stored in the storage sections;
a picking control means that outputs information of articles to be put in, which has been read from the storage section information-storage means, to a putting-in display response device, and outputs information of the articles and numbers of articles to be picked, to a picking display response device;
a putting-in operation display means that is provided on the putting-in display response device and that displays and directs a putting-in operation to the storage section for an operator; and a picking operation display means that is provided on the picking display response device and that displays and directs a picking operation from the storage section for an operator,
wherein in the course of assisting in tasks of putting-in work of putting articles into the storage sections of the storage racks as instructions have been issued, and tasks of picking articles from the storage sections as instructions have been issued, the picking control means controls assistance in both an operation to put in the articles and an operation to pick articles from the storage sections of the storage racks, on the basis of single items of positional information and article information for each of the storage sections that are stored in the storage section information-storage means.

2. The assistance in picking system according to claim 1, wherein the storage section information-storage means is constituted of a storage device of a computer, and wherein, in this storage device, names of articles, or of codes indicating these articles, that are to be stored in storage sections corresponding to identification codes of the storage sections, are stored as table data.

3. The assistance in picking system according to claim 1, wherein the storage sections on the storage racks are displayed on a screen of a computer in a mesh as cell, so that by inputting identification codes of the storage sections into the cells, allocation of the storage sections is set.

4. The assistance in picking system according to claim 2, wherein the names and the codes of articles and the identification codes of the storage sections are stored as a single data table, and as the identification codes of the storage sections, the identification codes of the putting-in display response device and those of the picking display response devices attached to the storage sections, are set in common with one another.

5. The assistance in picking system according to claim 3, wherein a display field which indicates the name of the article is provided on the storage section allocation input screen, and if the name of articles or the code indicating the articles corresponding to the identification codes of the storage sections is stored in the storage device, the name of the articles is displayed in the display field on the screen.
